(19) United States
(12) Patent Application Publication
(10) Pub. No.: US 2026/0165555 A1
(43) Pub. Date: Jun. 18, 2026

(54) Drying System and Method for Drying a Product

(71) Applicant: Weiss Technik GmbH, Reiskirchen (DE)

(72) Inventors: Yannik Zahrt, Rabenau (DE); Michael Weppler, Gruenberg (DE); Christian Haack, Marburg (DE); Maximilian Politschek, Lich (DE); Ralf Schimmel, Laubach (DE)

(21) Appl. No.: 19/124,444

(22) PCT Filed: Oct. 26, 2023
(86) PCT No.: PCT/EP2023/079917

§ 371 Date: Apr. 25, 2025

(30) Foreign Application Priority Data
Oct. 27, 2022 (DE) 10 2022 128 503.0

(51) Int. Cl. A47L 15/48; D06F 58/20; F26B 3/30; F26B 21/25

(52) U.S. Cl. CPC A47L 15/483; D06F 58/206; F26B 3/30; F26B 21/25

(57) ABSTRACT

A drying system for drying a product, in particular a medical product, an electronic product, a food product or the like, the drying system including a processing chamber in which the product can be disposed and a heating unit for heating the processing chamber and/or the product. The drying system comprises a moisture measuring unit having a trace-moisture measuring device for measuring a residual moisture, in particular in the processing chamber.

### CROSS-REFERENCE TO RELATED APPLICATIONS

This patent application is a national stage application of International Patent Application No. PCT/EP2023/079917 filed Oct. 26, 2023, which claims priority to German Patent Application No. 10 2022 128 503.0 filed Oct. 27, 2022, the disclosures of which is incorporated herein by reference in its entirety for all purposes.

### TECHNICAL FIELD

This disclosure relates to a drying system and a method for drying a product, in particular a medical product, an electronic product, a food product or the like, the drying system comprising a processing chamber in which the product can be disposed and a heating unit for heating the processing chamber and/or the product.

### BACKGROUND

A drying system of the type described above is known in practice and is regularly used to dry or dehumidify a product, which may be a medical product, an electronic product, a food product or the like, in a trace-moisture range. The term “trace moisture” refers to a small amount of moisture in the ppm range, in particular a range of ≤1000 ppm.

Such a drying system typically comprises a processing chamber, in which the product can be disposed, and a heating unit for heating the processing chamber and/or the product. To carry out a drying process, the product is then disposed in the processing chamber, dried by heating the processing chamber and/or the product and removed from the processing chamber as dried after a drying time has been reached. In doing so, the aim is for the trace moisture which remains in the dried product and is also referred to as the residual moisture of the product, to fall below a target moisture. However, since the drying time in the drying system known from practice is based exclusively on empirical values, it regularly happens that a product either does not remain long enough in the processing chamber so that the residual moisture of the product is above the desired target moisture, or a product remains longer than necessary in the processing chamber so that energy costs and process time are not used efficiently. This usually results in increased rejects and/or increased process costs.

### SUMMARY

The object of the present disclosure is therefore proposing a drying system and a method which enables a product to be dried at low cost while at the same time minimizing reject.

This object is attained by a drying system having the features disclosed herein and a method having the features disclosed herein.

The drying system according to the disclosure for drying a product, in particular a medical product, an electronic product, a food product or the like, the drying system comprising a processing chamber in which the product can be disposed and a heating unit for heating the processing chamber and/or the product, the drying system comprising a moisture measuring unit having a trace-moisture measuring device for measuring a residual moisture, in particular in the processing chamber.

The drying system according to the disclosure is suitable for drying and/or dehumidifying a solid product, such as a medical product, an electronic product, a food product or the like, and can be used to dry and/or dehumidify the product in the trace moisture range or ppm range. The product can be dried or dehumidified using the drying system in such a manner that the moisture or material moisture inherent in the product after drying using the drying system is in the trace moisture range, in particular ≤1000 ppm. If the moisture or material moisture of the product is already in the trace moisture range before drying, the residual moisture of the product can be further reduced using the drying system.

The drying system according to the disclosure comprises a processing chamber in which the product can be disposed and a heating unit for heating the processing chamber and/or the product. The product can therefore be heated directly and/or the product can be heated indirectly by heating the processing chamber. The heating of the product and/or processing chamber causes the temperature of the product and/or processing chamber and/or processing air in particular in the processing chamber to be controlled, as a result of which liquids or liquid substance-mixtures, in particular water and/or solvents, present in the product, for example in capillaries, these liquids or liquid substance-mixtures being responsible for the moisture or material moisture or residual moisture of the product, are converted into a gaseous aggregate state and can escape from the product into the processing air surrounding the product in order to dehumidify or dry the product. This can lead to a measurable increase in the moisture and/or residual moisture of the processing air.

The drying system according to the disclosure comprises a moisture measuring unit having a trace-moisture measuring device, i.e., a moisture measuring device configured for measuring a trace moisture, for measuring and/or determining a trace moisture or residual moisture of the product and/or a trace moisture or residual moisture in the processing chamber and/or in the processing air present in the processing chamber. The residual moisture is a trace moisture within the trace-moisture range. The trace-moisture measuring device can be provided and/or configured in particular for measuring the residual moisture of the processing air from which the residual moisture of the product can be determined or from which the residual moisture of the product can be inferred. The drying system according to the disclosure thus makes it possible to measure and/or determine the residual moisture of the product and/or the residual moisture in the processing chamber and/or the processing air present in the processing chamber during a drying process. During a drying process, it is therefore always possible to compare the current residual moisture of the product and/or the current residual moisture in the processing chamber and/or the processing air to a desired target moisture and to optimally adjust a drying time to the product. Energy costs and processing time can thus be efficiently utilized and waste can be reduced. The drying system according to the disclosure therefore allows a cost-effective drying of a product with a simultaneously low reject rate.

During a drying process and/or while the processing chamber and/or the product is heated, a vacuum can be formed in the processing chamber at least temporarily in order to carry out vacuum drying. This can reduce the boiling point of the liquids and/or liquid substance-mixtures according to a vapor pressure curve so that they can evaporate at comparatively low temperatures. This type of vacuum drying is particularly gentle on the product and can also reach areas within product geometries which are difficult to access.

The drying system can have a housing, in particular a cabinet-like housing. Accordingly, the drying system can be designed as a drying cabinet. The housing may have a door, by opening which the processing chamber can be released for disposing the product in the processing chamber and for removing the dried product from the processing chamber.

The drying system can comprise a temperature measuring unit for measuring a temperature in the processing chamber and/or the processing air and/or the product.

The drying system may comprise a pressure measuring unit for measuring a pressure in the processing chamber and/or the processing air.

The heating unit can be set up to heat the processing chamber and/or the processing air and/or the product to a temperature of up to +200° C. or more.

Advantageously, the heating unit can be designed as a jacket heating. For this purpose, the processing chamber and/or the housing can have a jacket which can surround the processing chamber. The heating unit can then heat the processing chamber on all sides. A heat exchanger medium can flow through the jacket. Preferably, an oil-based heat exchanger medium can be used as the heat exchanger medium. The design of the heating unit as a jacket heating ensures that potentially explosive atmospheres inside the processing chamber do not pose a risk to process safety.

Advantageously, the drying system can comprise an air-circulation unit for circulating processing air present in the processing chamber in order to achieve optimized heating of the processing chamber and/or the processing air and/or the product.

Advantageously, the drying system can comprise an inlet for supplying processing air and/or supply air in the processing chamber.

Advantageously, the drying system can comprise an outlet for discharging processing air and/or exhaust air from the processing chamber.

Advantageously, the air-circulation unit can comprise an air-circulation pipe connected to the outlet and the inlet and/or connecting the inlet to the outlet, the air-circulation unit being able to comprise a circulation device, preferably a fan, which is integrated in the air-circulation pipe and can be designed to let the processing air circulate via the air-circulation pipe in order to circulate the processing air in the processing chamber. By means of the circulation device, the processing air can then be evacuated and/or discharged from the processing chamber via the outlet and resupplied to the processing chamber via the inlet after passing through the air-circulation pipe. This allows a flow of processing air to be formed in the processing chamber, whereby uniform heating of the processing chamber and/or the processing air and/or the product can be achieved. The circulation device can have a fan or be designed as a fan. The fan can be designed as a radial fan or an axial fan. A drive motor of the fan can be disposed outside the air-circulation pipe, a fan wheel of the fan being able to be connected and/or coupled to the drive motor via a shaft of the fan.

The trace-moisture measuring device can work on the basis of the coulometric principle or on the basis of the oscillating quartz principle (Oscillating Quartz Crystal Microbalance). Accordingly, the trace-moisture measuring device can be designed as a coulometric moisture sensor or an oscillating-quartz-crystal moisture analyzer. Alternatively, the trace-moisture measuring device can also be designed as a metal-oxide moisture sensor.

Advantageously, the moisture measuring unit can be integrated in the air-circulation pipe in such a manner that the residual moisture of the processing air discharged from the processing chamber can be measured by means of the trace-moisture measuring device. The residual moisture can then be measured during operation of the air-circulation unit. Preferably, the moisture measuring unit and/or trace-moisture measuring device can then be disposed upstream of the circulation device and/or the fan as viewed in a flow direction of the processing air.

In one embodiment of the drying system, the trace-moisture measuring device can be disposed in the air-circulation pipe and/or integrated in the air-circulation pipe.

In an alternative embodiment of the drying system, the moisture measuring unit can comprise a bypass pipe which is connected to the air-circulation pipe and in which the trace-moisture measuring device can be disposed and/or in which the trace-moisture measuring device can be integrated. The moisture measuring device can further comprise a measuring gas pump disposed in the bypass pipe, preferably downstream of the trace-moisture measuring device, and/or a cooling path disposed in the bypass pipe, preferably upstream of the trace-moisture measuring device. The trace-moisture measuring device and possibly the measuring gas pump and/or the cooling path are then disposed in the bypass pipe parallel to the air-circulation pipe. By disposing the trace-moisture measuring device in the bypass pipe, a reduction in the flow velocity of the processing air in the air-circulation pipe can be avoided. A comparatively small amount of the processing air, which can form a measuring gas, can flow through the bypass pipe, which can be used to measure the residual moisture. The measuring gas pump can be used to ensure that the trace-moisture measuring device is continuously and accurately pressurized. The measuring gas can be cooled down by means of the cooling path and/or a cooling device if the temperature of the measuring gas is too high for the trace-moisture measuring device. Preferably, the measuring gas pump and/or the cooling path is disposed downstream or upstream of the trace-moisture measuring device as viewed in a flow direction of the measuring gas in the bypass pipe.

Advantageously, the drying system can comprise an evacuation unit for evacuating the processing chamber. By means of the evacuation unit, processing air can be discharged from the processing chamber and/or drying system, for example into an environment, and a vacuum can be formed and/or created in the processing chamber. In principle, it is conceivable that the vacuum is a rough vacuum, fine vacuum or high vacuum. The evacuation unit can be configured to create a pressure of at least <100 mbar in the processing chamber.

Advantageously, the evacuation unit can comprise an evacuation pipe and an evacuation device, preferably a vacuum pump, integrated in the evacuation pipe. Preferably, the evacuation pipe can be connected to the air-circulation pipe, preferably between the moisture measuring unit and/or the trace-moisture measuring device and the circulation device and/or the fan, resulting in a simplified arrangement. In addition, the residual moisture can thus also be measured during evacuation. After passing through the moisture measuring unit and/or the trace-moisture measuring device, for example via a three-way valve, the processing air can then either be resupplied to the processing chamber via the circulation device and/or the fan or be discharged from the drying system, for example into an environment, via the evacuation unit, depending on the operating mode of the drying system. It is also conceivable that the drying system comprises a further outlet to which the evacuation pipe can be connected.

Advantageously, the drying system can comprise a heat exchanger integrated in the evacuation pipe. Preferably, the heat exchanger can be disposed upstream of the evacuation device and/or the vacuum pump as viewed in a flow direction of the processing air in the evacuation pipe. The heat exchanger can be used to transfer heat from the processing air to a cooling medium. In this manner, energy recovery can be achieved and/or the processing air to be evacuated or discharged can be cooled.

Advantageously, the drying system can comprise a rinsing unit having at least one rinsing device for rinsing the processing chamber with a rinsing gas, in particular inert gas, preferably nitrogen or dry air. After rinsing the processing chamber with the rinsing gas, the rinsing gas may be present in the processing chamber and/or the processing chamber may be filled with the rinsing gas as processing air, possibly after a prior evacuation of the processing chamber by means of the evacuation unit, so that the rinsing gas can essentially form the processing air present in the processing chamber. The rinsing unit can comprise at least one rinsing pipe via which the rinsing device can be connected to the air-circulation pipe, preferably downstream of the circulation device and/or the fan as viewed in the flow direction of the processing air in the air-circulation pipe, so that the rinsing gas can enter the processing chamber, preferably via the inlet, resulting in a simplified arrangement. It is also conceivable that the drying system comprises a further inlet to which the rinsing pipe can be connected.

Furthermore, the rinsing device can have a metering valve by means of which a quantity of rinsing gas can be metered. In an advantageous embodiment of the drying system, the drying system can comprise two rinsing devices, a first rinsing device being able to be configured to rinse the processing chamber with nitrogen and a second rinsing device being able to be configured to rinse the processing chamber with dry air. The rinsing unit can then comprise two rinsing lines.

Further advantageous embodiments of the drying system result from the feature descriptions of the method.

In the method according to the disclosure for drying a product, in particular a medical product, an electronic product, a food product or the like, by means of a drying system, the product is disposed in a processing chamber of the drying system, the processing chamber and/or the product being heated by means of a heating unit of the drying system, a residual moisture, in particular in the processing chamber, being measured by means of a trace-moisture measuring device of a moisture measuring unit of the drying system.

With regard to the advantageous effects of the method according to the disclosure, reference is made to the description of the advantages of the drying system according to the disclosure.

Advantageously, the arrangement of the product in the processing chamber can be carried out at an ambient temperature. The processing chamber can then be at ambient temperature.

Advantageously, the residual moisture in the processing chamber and/or a processing air present in the processing chamber can be measured. A residual moisture of the product can be determined from the residual moisture of the processing air and/or the residual moisture of the product can be inferred. Accordingly, the residual moisture of the product can be easily determined from the residual moisture in the processing chamber and/or the processing air.

During the heating of the processing chamber and/or the product, a vacuum can be formed at least temporarily in the processing chamber in order to carry out vacuum drying.

Advantageously, by heating the processing chamber and/or the product, the processing chamber and/or the product can be heated to a target temperature.

The residual moisture can be measured during the heating of the processing chamber and/or the product.

Advantageously, the residual moisture can be measured and/or determined at least once after the target temperature has been reached.

The residual moisture can also be measured at least once after heating the processing chamber and/or the product.

Advantageously, the residual moisture can be compared to a target moisture. As soon as the target moisture is reached or has been fallen below, the drying process can be ended. The dried product can then be removed from the processing chamber, preferably after the processing chamber has cooled down, preferably to the ambient temperature.

Advantageously, the processing air present in the processing chamber can be circulated at least temporarily by means of an air-circulation unit of the drying system while the processing chamber and/or the product is being heated in order to achieve uniform heating of the processing chamber and/or the processing air and/or the product. The residual moisture can be measured while the air-circulation unit is in operation in order to obtain a reliable value for the residual moisture.

Advantageously, the residual moisture of the processing air and/or exhaust air discharged from the processing chamber during or as a result of the circulation of the processing air in the processing chamber can be measured.

Advantageously, the processing chamber can be evacuated by means of an evacuation unit of the drying system before the processing chamber and/or the product is heated, and the processing chamber can be rinsed with a rinsing gas, in particular inert gas, preferably nitrogen or dry air, by means of at least one rinsing device of a rinsing unit of the drying system after the processing chamber has been evacuated in such a manner that the rinsing gas can be present in the processing chamber after the processing chamber has been rinsed with the rinsing gas. During evacuation, a vacuum can initially be formed or built up in the processing chamber. A pressure in the processing chamber, which can correspond to an ambient pressure before evacuation, can then be <100 mbar, for example. During evacuation, comparatively high-moisture air and/or processing air, which may initially be present in the processing chamber, for example because ambient air may have flowed into the processing chamber due to the placement of the product in the processing chamber, can be discharged from the processing chamber or drying system, for example to an environment. During rinsing, the vacuum previously built up in the processing chamber as a result of evacuating the processing chamber can be released again. The pressure in the processing chamber can then essentially correspond to an ambient pressure after the processing chamber has been rinsed with the rinsing gas. Since the inert gas is particularly free of water vapor, rinsing and/or filling the processing chamber with the rinsing gas can initially result in essentially dry processing air in the processing chamber after rinsing. In principle, evacuation can also take place without rinsing and rinsing without evacuation.

Advantageously, the residual moisture can be measured before heating the processing chamber and/or the product to determine an initial value. Advantageously, the residual moisture can be measured after evacuating and rinsing the processing chamber with the rinsing gas to determine the initial value. Advantageously, the heating of the processing chamber and/or the product can take place after the residual moisture has been measured in order to determine the initial value.

Advantageously, in particular if the residual moisture, preferably measured after the target temperature has been reached, is above the target moisture, the processing chamber can be evacuated at least once by means of an and/or the evacuation unit of the drying system while the processing chamber and/or the product is heated, preferably to the target temperature, or after the processing chamber and/or the product has been heated, and the processing chamber can be rinsed with a and/or the rinsing gas, in particular inert gas, preferably nitrogen or dry air, by means of at least a and/or the rinsing device of a and/or the rinsing unit of the drying system after the processing chamber has been evacuated in such a manner that the rinsing gas is present in the processing chamber after the processing chamber has been rinsed with the rinsing gas. Evacuation and subsequent rinsing can therefore each take place at least once. During evacuation, a vacuum can initially be formed and/or built up in the processing chamber. A pressure in the processing chamber, which can correspond to an ambient pressure before evacuation, can then be reduced to a target pressure, for example <100 mbar. As a result of heating the processing chamber and/or the product, liquid located in the product can or could be converted into a gaseous aggregate state and increase the moisture and/or residual moisture of the processing air, which may previously have been essentially dry. During evacuation, this processing air, which has a comparatively high moisture and/or residual moisture, can be removed from the processing chamber. During rinsing, the vacuum previously built up in the processing chamber as a result of evacuating the processing chamber can be released again. The pressure in the processing chamber after the processing chamber has been rinsed with the rinsing gas can then essentially correspond to an ambient pressure. Since the inert gas is particularly free of water vapor, rinsing and/or filling the processing chamber with the rinsing gas can initially result in essentially dry processing air in the processing chamber after rinsing. If evacuation and rinsing takes place during heating, the air-circulation unit can be switched off during evacuation and rinsing and be switched on again after evacuation and rinsing. If the evacuation and rinsing takes place after heating, the heating can be continued after the evacuation and rinsing, if necessary after measuring the residual moisture. In principle, evacuation can also take place without rinsing and rinsing without evacuation.

The residual moisture can be measured after evacuation and rinsing.

Advantageously, the evacuation of the processing chamber and the rinsing of the processing chamber with the rinsing gas and, if necessary, the continuation of heating, if the evacuation and rinsing take place after the heating, can be repeated until the residual moisture reaches or falls below the target moisture. The residual moisture can thus be successively reduced by running through the above loop until the desired target moisture is reached.

The target moisture can be between 1 ppm and 1000 ppm, for example.

Further advantageous embodiments of the method result from the feature descriptions of the device.

In the following, preferred embodiments of the disclosure are explained in more detail with reference to the accompanying drawings.

### BRIEF DESCRIPTION OF THE FIGURES

FIG. 1 shows a schematic diagram of a drying system.

FIG. 2a shows a partial schematic diagram of a further drying system in an area of a moisture measuring unit of the drying system.

FIG. 2b shows a partial schematic diagram of a further drying system in an area of a moisture measuring unit of the drying system.

FIG. 2c shows a partial schematic diagram of a further drying system in an area of a moisture measuring unit of the drying system.

FIG. 3 shows a flow chart of a method for drying a product.

FIG. 4 shows a diagram of a residual moisture over a period of time during the method.

### DETAILED DESCRIPTION

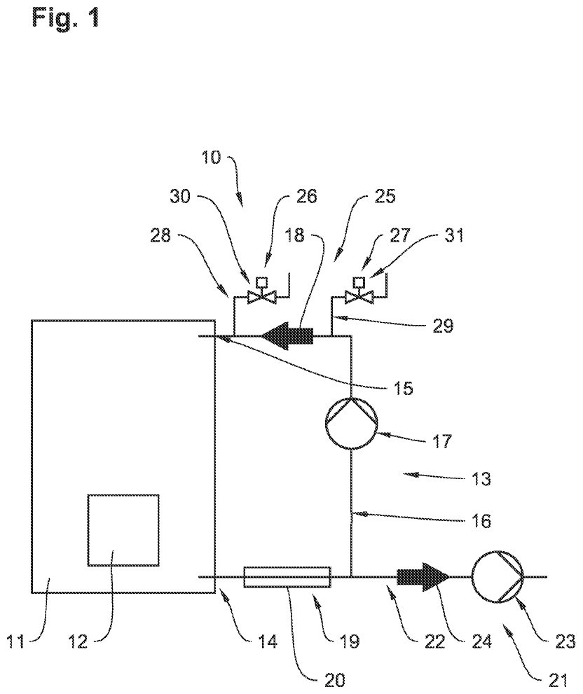

FIG. 1 shows a drying system 10, comprising a processing chamber 11, in which a product 12 is disposed, and a heating unit designed as a jacket heating and for heating the processing chamber 11 and the product 12, the heating unit not being shown here. Furthermore, the drying system 10 comprises an air-circulation unit 13 for circulating processing air present in the processing chamber 11. The air-circulation unit 13 comprises an air-circulation pipe 16 connected to an outlet 14 of the drying system 10 and to an inlet 15 of the drying system 10 and a fan 17 integrated in the air-circulation pipe 16 and configured to let the processing air circulate in a flow direction marked by an arrow 18 via the air-circulation pipe 16 in order to circulate the processing air in the processing chamber 11. Furthermore, the drying system 10 comprises a moisture measuring unit 19 integrated in the air-circulation pipe 16 upstream of the fan 17 as viewed in the direction of flow and having a trace-moisture measuring device 20 which is disposed in the air-circulation pipe 16 and by means of which a residual moisture of processing air discharged from the processing chamber 11 via the outlet 14 can be measured. Furthermore, the drying system 10 comprises an evacuation unit 21 for evacuating the processing chamber 11. The evacuation unit 21 comprises an evacuation pipe 22 connected to the air circulation pipe 16 between the moisture measuring unit 19 and/or the trace moisture device 20 and the fan 17, and a vacuum pump 23. By means of the vacuum pump 23, processing air can be evacuated and/or discharged from sections of the processing chamber 11 via the air circulation pipe 16 and in a further flow direction marked by an arrow 24 via the evacuation pipe 22, for example into an environment. In addition, the drying system 10 comprises a rinsing unit 25 having a first rinsing device 26 for rinsing the processing chamber 11 with nitrogen and a second rinsing device 27 for rinsing the processing chamber 11 with dry air. The first rinsing device 26 and/or second rinsing device 27 is connected to the air-circulation pipe 16 via a first rinsing line 28 of the rinsing unit 25 and/or second rinsing line 29 of the rinsing unit 25 downstream of the fan 17 as viewed in the direction of flow so that the nitrogen and/or dry air can enter the processing chamber 11 via the inlet 15. The first rinsing device 26 and/or second rinsing device 27 has a first metering valve 30 and/or second metering valve 31.

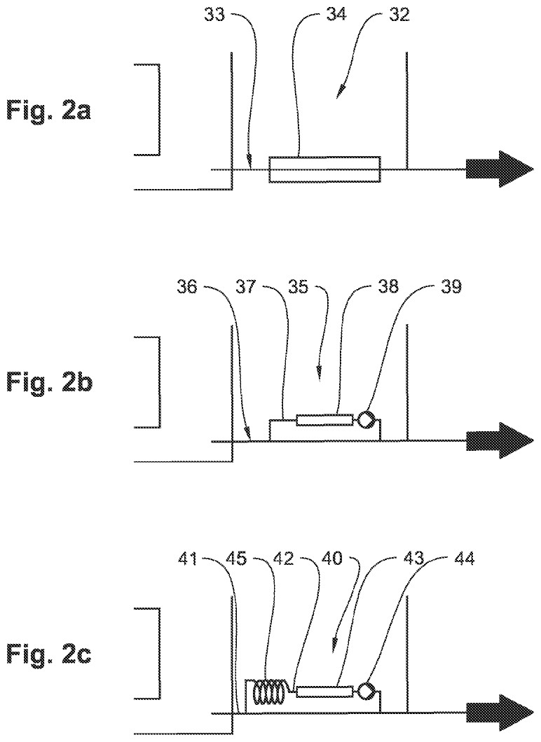

FIG. 2a shows a moisture measuring unit 32 of a drying system (not shown) having a trace-moisture measuring device 34 disposed in an air-circulation pipe 33 of an air-circulation unit (not shown) of the drying system. The moisture measuring unit 32 corresponds to the moisture measuring unit 19. In this respect, FIG. 2a can be understood as a partial view of FIG. 1 in an area of the moisture measuring unit 19. The drying system can therefore be the drying system 10.

FIG. 2b shows a moisture measuring unit 35 of a drying system (not shown) having a bypass pipe 37 which is connected to an air-circulation pipe 36 of an air-circulation unit (not shown) of the drying system and in which a trace-moisture measuring device 38 of the moisture measuring unit 35 is disposed, the moisture measuring unit 35 further comprising a measuring gas pump 39 disposed in the bypass pipe 37 downstream of the trace-moisture measuring device 38. The drying system can also be designed in the same manner as the drying system 10.

FIG. 2c shows a moisture measuring unit 40 of a drying system (not shown) having a bypass pipe 42 which is connected to an air-circulation pipe 41 of an air-circulation unit (not shown) of the drying system and in which a trace-moisture measuring device 43 of the moisture measuring unit 40 is disposed, the moisture measuring unit 40 further comprising a measuring gas pump 44 disposed in the bypass pipe 42 downstream of the trace-moisture measuring device 43 and a cooling path 45 disposed in the bypass pipe 42 upstream of the trace-moisture device 43. The drying system can also be designed in the same manner as the drying system 10.

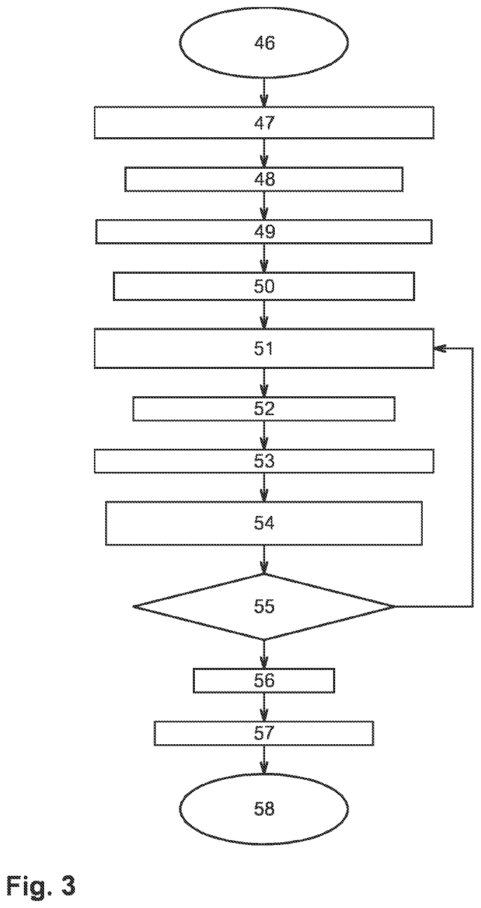

FIG. 3 shows a flow chart of a method for drying the product 12. The method is carried out using the drying system 10. After a start 46, the product 12 is disposed in the processing chamber 11 in a first step 47. The processing chamber 11 is then evacuated in a second step 48, preferably to a pressure of <100 mbar, by means of the evacuation unit 21 and subsequently rinsed to an ambient pressure in a third step 49 by means of the rinsing unit 25. Subsequently, in a fourth step 50, an initial measured value of a residual moisture located in the processing chamber 11 is measured and/or determined by means of the trace-moisture measuring device 20. In a fifth step 51, the processing chamber 11 and the product 12 are heated to a target temperature by means of the heating unit during operation of the air-circulation unit 13. After heating, the processing chamber 11 is evacuated to a target pressure in a sixth step 52 by means of the evacuation unit 21 and then rinsed to ambient pressure in a seventh step 53 by means of the rinsing unit 25. In an eighth step 54, the residual moisture of the residual moisture located in the processing chamber 11 is measured and/or determined by means of the trace-moisture measuring device 20 and compared to a target moisture in a ninth step 55. The fifth step 51, the sixth step 52, the seventh step 53, the eighth step 54 and the ninth step 55 are repeated until the target moisture is reached or fallen below. The sixth step 52, the seventh step 53, the eighth step 54 and the ninth step 55 can also be carried out during heating, in particular while the processing chamber and the product are heated to the target temperature, so that in this case the sixth step 52, the seventh step 53, the eighth step 54 and the ninth step 55 can be repeated until the target moisture is reached or fallen below. The eighth step 54 and the ninth step 55 can also be carried out before the sixth step 52. When the residual moisture reaches or falls below the target moisture, the processing chamber 11 can be cooled down in a tenth step 56 and the product 12 can be removed and/or withdrawn from the processing chamber 11 in an eleventh step 57. An end 58 is reached.

Of course, the method can also be carried out using the drying systems shown in FIGS. 2a to 2c.

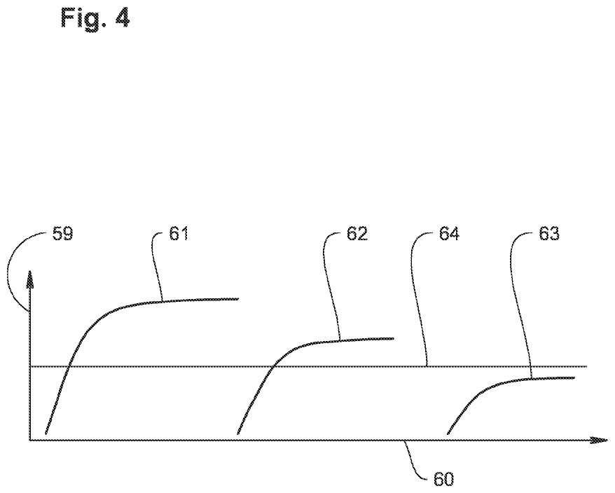

FIG. 4 shows a residual moisture and/or a moisture content on an ordinate 59 and/or a saturation of the processing air over time on an abscissa 60 during the execution of the method according to the flow chart shown in FIG. 3. Shown are a first measurement curve 61, a second measurement curve 62 and a third measurement curve 63 for the residual moisture. The measurement curves 61, 62, 63 initially increase in each case because the liquid, in particular water, located in the product 12 is converted into a gaseous aggregate state as a result of the heating and enters the processing air, and then finally reach a substantially constant value (not shown) running essentially parallel to the abscissa 60 in each case. FIG. 4 illustrates how the residual moisture can be successively reduced by repeating the sixth step 52 and the seventh step 53 twice in the present example until the residual moisture is below a target moisture indicated by a straight line 64.

1. A drying system for drying a product, the drying system comprising a processing chamber in which the product is disposable and a heating unit for heating the processing chamber and/or the product, wherein
the drying system comprises a moisture measuring unit having a trace-moisture measuring device for measuring a residual moisture in the processing chamber.

2. The drying system according to claim 1, wherein
the heating unit is designed as a jacket heating.

3. The drying system according to claim 1, wherein
the drying system comprises an air-circulation unit for circulating processing air present in the processing chamber.

4. The drying system according to claim 3, wherein
the drying system comprises an outlet for discharging processing air from the processing chamber and an inlet for supplying processing air in the processing chamber, the air-circulation unit comprising an air-circulation pipe connected to the outlet and the inlet, the air-circulation unit comprising a circulation device which is integrated in the air-circulation pipe and is designed to let the processing air circulate via the air-circulation pipe in order to circulate the processing air in the processing chamber.

5. The drying system according to claim 4, wherein
the moisture measuring unit is integrated in the air-circulation pipe in such a manner that the residual moisture of the processing air discharged from the processing chamber is measurable by the trace-moisture measuring device.

6. The drying system according to claim 5, wherein
the trace-moisture measuring device is disposed in the air-circulation pipe.

7. The drying system according to claim 5, wherein
the moisture measuring unit comprises a bypass pipe which is connected to the air-circulation pipe and in which the trace-moisture measuring device is disposed, the moisture measuring unit further comprising a measuring gas pump disposed in the bypass pipe and/or a cooling path disposed in the bypass pipe.

8. The drying system according to claim 1, wherein
the drying system comprises an evacuation unit for evacuating the processing chamber.

9. The drying system according to claim 8, wherein
the evacuation unit comprises an evacuation pipe and an evacuation device integrated in the evacuation pipe.

10. The drying system according to claim 9, wherein
the drying system comprises a heat exchanger integrated in the evacuation pipe.

11. The drying system according to claim 1, wherein
the drying system comprises a rinsing unit having at least one rinsing device for rinsing the processing chamber with a rinsing gas.

12. A method for drying a product with a drying system, the product being disposed in a processing chamber of the drying system, the processing chamber and/or the product being heated by a heating unit of the drying system, wherein
a residual moisture in the processing chamber is measured by a trace-moisture measuring device of a moisture measuring unit of the drying system.

13. The method according to claim 12, wherein
the processing chamber and/or the product is heated to a target temperature, the residual moisture being measured at least once after reaching the target temperature.

14. The method according to claim 12, wherein
processing air present in the processing chamber is circulated by an air-circulation unit of the drying system at least temporarily while the processing chamber and/or the product is heated.

15. The method according to claim 14, wherein
the residual moisture of the processing air discharged from the processing chamber while circulating the processing air in the processing chamber is measured.

16. The method according to claim 12, wherein
the processing chamber is evacuated by an evacuation unit of the drying system before the processing chamber and/or the product is heated, and the processing chamber is rinsed with a rinsing gas by at least one rinsing device of a rinsing unit of the drying system after the processing chamber has been evacuated in such a manner that the rinsing gas is present in the processing chamber after the processing chamber has been rinsed with the rinsing gas.

17. The method according to claim 1, wherein
the processing chamber is evacuated at least once by an evacuation unit of the drying system while or after the processing chamber and/or the product is heated, and the processing chamber is rinsed with a rinsing gas by at least a rinsing device of a rinsing unit of the drying system after the processing chamber has been evacuated in such a manner that the rinsing gas is located in the processing chamber after the processing chamber has been rinsed with the rinsing gas.

18. The method according to claim 17, wherein
evacuation and rinsing of the processing chamber with the rinsing gas is repeated until the residual moisture has reached or fallen below a target moisture.
